(19) United States
(12) Patent Application Publication
(10) Pub. No.: US 2026/0050843 A1
(43) Pub. Date: Feb. 19, 2026

(54) AIRLINE FLIGHT TICKET MANAGEMENT SYSTEM AND SWAP-TICKET METHOD THEREFOR

(71) Applicant: SWAP TICKET LLC, Miami, FL (US)

(72) Inventors: Alexis Carlitos Hertz, Miami, FL (US); Sacha George Hertz, Miami, FL (US)

(21) Appl. No.: 18/806,024

(22) Filed: Aug. 15, 2024

(51) Int. Cl. G06Q 10/02; G06F 16/23; G06Q 30/0208; G06Q 50/40

(52) U.S. Cl. CPC G06Q 10/02; G06F 16/2379; G06Q 30/0208; G06Q 50/40

(57) ABSTRACT

A flight ticket management server (Server) includes flight ticket records (Records) each associated with a seat on an airline flight. Each Record includes permanent flight ticket swap offer details from a seller of a previously purchased and unused flight ticket. The Server sends Query Messages to seller's computer devices. Each computer device sends an Automatic Response, without human intervention and independent of a user of the computer device, indicating any seller requested changes to local flight ticket swap offer details stored in a local repository in the computer device. The Server generates a web page. The web page displays a) permanent flight ticket swap offer details from the Record, and b) local flight ticket swap offer details from the local repository, and a button that when selected via a browser in the computer device confirms seller's manual selection of a) or b) for current permanent flight ticket swap offer details.

### CROSS-REFERENCE TO RELATED APPLICATIONS

N/A

### FEDERALLY SPONSORED RESEARCH AND DEVELOPMENT

N/A

### FIELD OF THE DISCLOSURE

The present disclosure generally relates to flight ticket management systems and methods, and more particularly to an information processing system for automatically managing flight ticket sales between sellers and buyers of the flight tickets.

### BACKGROUND

After purchasing an airline flight ticket, for various reasons, a purchaser of a flight ticket is not able to use the flight ticket. Certain conditions might preclude the purchaser from being reimbursed for the purchased ticket which is not usable by the purchaser. Also, the purchaser may not be permitted by the airline to transfer the flight ticket to another person.

This situation also results in an empty seat in the plane due to the unused flight ticket, while there might be other buyers for the flight ticket to fill the empty seat. This can reduce the airline's efficiency in filling seats, and detrimentally affects profitability due to unused flight tickets and empty seats on flights. The loss in efficiency and the resulting empty seats on flights can significantly increase the cost of airline operations.

### SUMMARY OF THE DISCLOSURE

Various example implementations of the present disclosure provide a flight ticket management server (Server) which includes flight ticket records (Records) each associated with a seat on an airline flight. Each Record includes permanent flight ticket swap offer details from a seller of a previously purchased and unused flight ticket. The Server sends Query Messages to seller's computer devices. Each computer device sends an Automatic Response, without human intervention and independent of a user of the computer device, indicating any seller requested changes to local flight ticket swap offer details stored in a local repository in the computer device. The Server generates a web page. The web page displays a) permanent flight ticket swap offer details from the Record, and b) local flight ticket swap offer details from the local repository, and a button that when selected via a browser in the computer device confirms seller's manual selection of a) or b) for current permanent flight ticket swap offer details.

Features and advantages of the above-described various embodiments will become readily apparent from the following description and accompanying drawings. Certain preferred embodiments of the invention and their benefits will also become more apparent to a person of ordinary skill in the art through the description and selected examples given herein below, and through the appended claims.

All references, publications, patents, and patent applications, cited herein and/or cited in any accompanying Information Disclosure Statement (IDS), are hereby incorporated herein by reference in their entirety for all purposes.

### BRIEF DESCRIPTION OF THE DRAWINGS

The accompanying figures, in which like reference numerals refer to identical or functionally similar elements throughout the separate views, and which together with the detailed description below are incorporated in and form part of the specification, serve to illustrate various examples and to explain various principles and advantages all in accordance with the present disclosure, in which:

FIG. 1 is a block diagram illustrating an example flight ticket management system according to various embodiments of the invention;

FIG. 2 is an example seating map for a flight, suitable for use by the flight ticket management system of FIG. 1;

FIG. 3 is a block diagram illustrating an example information processing system suitable for use in a flight ticket management system such as shown in FIG. 1, according to various embodiments of the invention;

FIG. 4 is a block diagram illustrating an example user computer device such as shown in FIG. 1, according to various embodiments of the invention;

FIG. 5 illustrates a more detailed view of an example of a flight ticket inventory database system such as shown in FIG. 1;

FIG. 6 illustrates a more detailed view of an example of a flight ticket swap seller data repository, as shown in FIG. 1; and

FIGS. 7 to 10 and 12 are operational flow diagrams illustrating an example set of operations of the system of FIG. 1, according to various embodiments of the invention.

FIG. 11 is a timing diagram showing an example flight ticket swap process according to various embodiments of the invention.

### DETAILED DESCRIPTION

As required, detailed embodiments are disclosed herein; however, it is to be understood that the disclosed embodiments are merely examples and that the devices, systems, and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any proprietary detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

### Non-Limiting Definitions

The term “multiplicity”, is intended to mean herein a large number, at least greater than ten, likely greater than 100, and possibly greater than 1000.

As used herein, the term “Query Message” is intended to mean herein a swap process query email message (e.g., TCP/IP email message using the SMTP protocol message format) in which each message includes an address that identifies a remote computer device as the destination of the message being communicated through one or more computer network(s). Additionally, a web page link information field is provided in the query email message. This web page link in the email message is available for the user of the computer device to “click the link” and use a browser to point to a web page created by a commercial carrier ticket management server to facilitate the user to manually confirm the user's request to make a change to information contained in the Query Message received from the server.

As used herein, the term “destined for reception” is intended to mean herein, in the context of a transmitted message, that a transmitted message includes address information that identifies a remote computer device as the destination of the message being communicated through communication network(s) of computer devices. The message is thereby addressed to be received from the communication network(s) of computer devices by the destination computer device identified by the address information in the message.

As used herein, the terms “Automatic Response Message”, “Automatic Response”, and the like, are intended to mean herein an automatic response message transmitted from a remote computer device, without human intervention and transmitted independent of a user being present at and using the remote computer device at the time of transmission, in response to a Query Message. The automatic response message is transmitted from a remote computer device to a flight ticket management server, or its equivalent computer system. The automatic response message includes address information that identifies a commercial carrier ticket management server, or its equivalent computer system, as the destination of the automatic response message being communicated through one or more computer networks from the remote computer device to the commercial carrier ticket management server, or its equivalent. The one or more computer networks that communicate the automatic response message can be different from the one or more networks that communicate the Query Message. For example, and not for limitation, the Query Message could be transmitted through a first computer network using TCP/IP packet communication protocol and using the SMTP protocol email message format. According to the example, the automatic response message could be transmitted through a different communication channel as one or more data packets through SMS (Short Message Services), RCS (rich communication services), or Multimedia Messaging Service (MMS), via standard communication protocols used by most telephone, Internet, and mobile devices.

As used herein the terms “pass”, “ticket”, and the like, are intended to mean, as understood in context of use of the particular term, an official document or ticket, not necessarily in a tangible or paper form, and which could be an electronic document or ticket, showing that one has a reserved right to any one or more of:
a) to go somewhere, for example and not for limitation, to be a guest of any one of a hotel, or a guest of a club's facilities, a guest of a short-term and long-term homestay available from a service provider such Airbnb, or the like; or
b) to be a passenger and use a particular form of transportation on a trip, such as any one or more of a commercial carrier trip, an airplane flight, a bus trip, a train trip, or a cruise ship cruise, or the like.

As used herein the term “commercial carrier” is intended to mean, as understood in context of use of the term, a form of passenger transportation, for example, and not for limitation, an airplane, a bus, a train, or a cruise ship, or the like, for which a pass or ticket shows that a person, a pet, or the like, has reserved a right to be a passenger.

### Introduction

The inventors have observed that in many airline operating scenarios after purchasing an airline flight ticket, for various reasons, a purchaser of a flight ticket is not able to use the flight ticket. Certain conditions might preclude the purchaser from being reimbursed for the purchased ticket which is not usable by the purchaser. Also, the purchaser may not be permitted by the airline to transfer the flight ticket to another person.

This situation also results in an empty seat in the plane due to the unused flight ticket, while there might be other buyers for the flight ticket to fill the empty seat. This can reduce the airline's efficiency in filling seats, and detrimentally affects profitability due to unused flight tickets and empty seats on flights. The loss in efficiency and the resulting empty seats on flights can significantly increase the cost of airline operations.

Various embodiments of the present invention can dramatically improve the efficiency of airlines to process otherwise unused flight tickets to fill otherwise empty seats on airline flights. According to an automated flight ticket swap process that requires no human intervention at the airline, compensation can be provided to previous purchasers of unused unexpired flight tickets by allowing the airline to facilitate, under certain conditions, the flight ticket swap process between the seller of the unused and unexpired flight ticket and a subsequent buyer of the flight ticket.

A flight ticket swap process, according to certain example implementations, can be considered similar to a fixed-price ticket consignment offer that is facilitated by the flight ticket management server. The consignment flight ticket is swapped between a seller computer device, that is swapping the flight ticket with assistance from the airline computer system, and a buyer computer device which is buying the consignment flight ticket with assistance from the airline computer system.

According to various embodiments, as will be discussed in more detail by examples presented below, a flight ticket swap system (also referred to as System) 100 and method can contemporaneously manage individualized flight ticket swap processes between a flight ticket management server and a multiplicity of remotely located networked computer devices of respective sellers of previously purchased, unused, and unexpired flight tickets. Each seller's computer device can be in a separate automatic flight ticket swap process with an airline computer system, where the seller computer device is requesting the airline computer system to sell (e.g., swap) their previously purchased, unused, and unexpired flight ticket, with a buyer of the flight ticket. Such buyer of the flight ticket, according to various embodiments, can be using their own computer device to communicate with the airline's flight ticket management server.

The automatic flight ticket swap process with the airline computer system can take days or even weeks, or longer, while the seller's flight ticket can be offered to be sold to prospective buyers. Therefore, the seller might have time to reconsider their seller swap offer details and make one or more changes to the seller swap offer while waiting for the flight ticket to be sold to prospective buyers.

The flight ticket management server sends swap process query email messages, also referred to as Query Messages, to email addresses of respective computer devices of individual users (also referred to as Sellers) that are each requesting to swap (sell to a subsequent buyer with assistance from an airline computer system) their previously purchased, unused, and unexpired, flight ticket in a flight ticket swap process managed by the flight ticket management server, as will be discussed below.

The Query Messages can include current status information associated with the individual user's (the Seller's) flight ticket in the flight ticket swap process, in accordance with a seller swap offer that is being followed by the flight ticket management server. The seller swap offer and flight ticket swap process are specific to the user of the computer device who is also referred to herein as the Seller of the flight ticket. The flight ticket management server contemporaneously manages at near real-time many different seller swap offer and flight ticket swap process. A human, even while using conventional basic computer tools, will not be able to keep track of and perform all these contemporaneous flight ticket swap processes, which are time sensitive and different from each other, and can change often during the flight ticket swap processes.

The Query Messages also include a request for an automatic response message (Automatic Response) from the remote computer device of the Seller. The Automatic Response, in response to the remote computer device receiving the Query Message, can provide current user information and user changes to their permanent seller swap offer which such information is stored and updated by the flight ticket management server in a flight ticket inventory database.

The Query Messages can be repeatedly sent to the remote computer devices of sellers of respective flight tickets while in different contemporaneous flight ticket swap processes with the airline computer system. These Query Messages can repeatedly confirm by message communications with the computer device of each individual seller 1) the details of the current seller swap offer, and 2) receive from each individual seller a manual confirmation of any changes the seller might want to make to their current seller swap offer, as will be discussed in more detail by examples provided below.

While the above discussion is generally directed toward embodiments of a system and method for processing swaps of tickets for airplane flights from sellers of previously purchased tickets, the discussions herein are similarly applicable more generally to processing swaps of tickets for commercial carrier trips from sellers of previously purchased tickets.

Moreover, according to various embodiments, the discussions herein are similarly applicable more generally to processing swaps of tickets for going somewhere, such as to be a guest of any one of a hotel, or a guest of a club's facilities, or a guest of a short-term and long-term homestay available from a service provider such as Airbnb, or the like, from sellers of previously purchased tickets.

### Description of Various Example Embodiments

The below-described examples of systems and methods provide various technical solutions for more efficiently operating a flight ticket management system during most operating conditions for an airline.

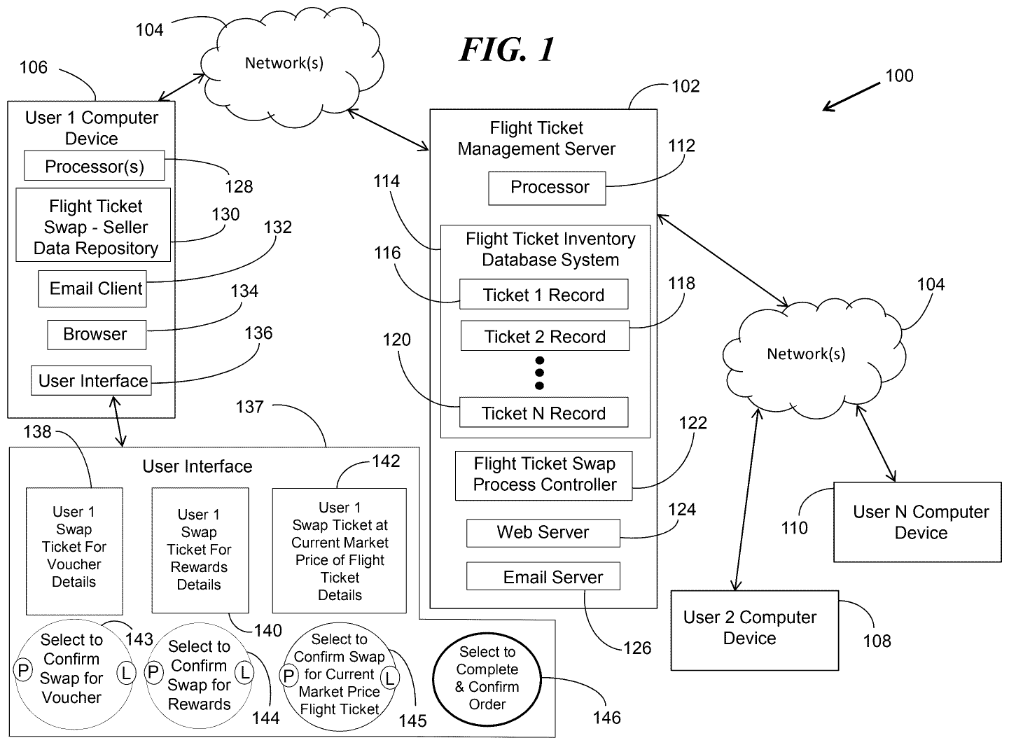

Referring to FIG. 1, an example of a flight ticket swap system 100 is shown. A flight ticket management server 102 is communicatively coupled with one or more networks 104. One or more user computer devices 106, 108, 110, are communicatively coupled with the networks 104. The flight ticket management server 102 includes one or more processors 112 and a flight ticket inventory database system 114 including one or more flight ticket records 116, 118, 120. Server 102 also includes a flight ticket swap process controller 122, a web server 124, and an email server 126, as will be discussed in more detail below.

A user computer device 106 includes one or more processors 128, a flight ticket swap seller data repository 130, an email client 132, a browser 134, and a user interface 136. Computer device 106 is representative of the various computer devices 106, 108, 110, communicatively coupled with the one or more networks 104. This user computer device 106 is illustrated in more detail as an example, and not for limitation, showing example components of the user computer device 106.

User interface 136, according to the example, includes a display interface 137 which can visually communicate with a user of the user computer device 106. The display user interface 137 is showing various display elements 138, 140, 142, 143, 144, 145, 146. Certain display elements 143, 144, 145, 146, are selectable by a user of the computer device 106. These display elements will be discussed in more detail further below.

An email client 132, operating in the computer device 106, can communicate via the networks 104 to receive and send email messages. The email client 132 is associated with one or more email addresses stored in non-volatile storage memory (persistent memory) in the computer device 106. An email message sent, by an email server 126, in the networks 104 includes an email address, typically in a header portion of the email message. The email client 132, via the computer device 106, monitors email communications from the networks 104 and determines that a particular email message is destined for reception by the email client 132, based on comparing an email address included in the particular email message to the one or more email addresses stored in the storage memory and finding a match between the email address included in the particular email message and one of the one or more email addresses stored in the storage memory. Such an email message may also be referred herein as being addressed and destined for reception by the email client 132 in the computer device 106.

According to the present example shown in FIG. 1, the email server 126 receives a Query Message from the swap ticket process controller 122. The Query Message is addressed and destined for reception by, in this example, the email client 132 in the seller user computer device 106. The email server 126 then sends the Query Message into the network 104 wherein the Query Message has been addressed and destined for reception, via the network 104, by the email client 132.

After the email client 132 has determined that the email message is addressed and destined for reception by the email client 132, the email client 132 receives the email message and stores it in memory in the computer device 106.

Additionally, in response to receiving the Query Message according to this example, the processor 128 interoperates with the email client 132 to generate an Automatic Response. The generated Automatic Response includes an address of the email server 126 in the server 102. This address information is typically included in a header portion of the Automatic Response. This address information indicates that the Automatic Response is addressed and destined for reception by the email server 126 in the flight ticket management server 102. The Automatic Response includes the individual user's local seller ticket swap data collected by, and stored in the local storage memory repository 130 in the seller's computer device 106. The email client 132 then transmits the Automatic Response from the computer device 106, via the computer network 104, to the email server 126 in the flight ticket management server 102.

The email server 126, in response to receiving the Automatic Response, transfers the Automatic Response payload information (e.g., the message information transported by the Automatic Response) to the swap ticket process controller 122.

The Automatic Response payload information includes the seller's ticket swap data 422 collected by, and stored in the local storage memory repository 130 of, the seller's computer device 106. The flight ticket swap process controller 122 then copies the seller's ticket swap data 422 from the Automatic Response payload information, and stores it in the flight ticket record 116 in the database 114.

The flight ticket swap process controller 122 can repeat this process for all the computer devices 106, 108, 110. In this way, the flight ticket management server 102 can automatically keep track of the current seller's ticket swap data 422 that is received from each computer device 106, 108, 110, as part of responding to the Query Messages sent to the computer devices 106, 108, 110.

A user of the email client 132 can cause the email client to display the displayable information from the stored email message on a display screen of a user interface 136 (e.g., on a display) of the computer device 106, in a manner that is well known to those of ordinary skill in the art. In certain embodiments, the email client 132 can be configured such that in response to receiving the Query Message the email client 132 automatically displays the stored email message on a display screen 137 of the user interface 136. The display of the email message on the display screen 137 of the user interface 136 is not shown in FIG. 1. But this process is understood by those of ordinary skill in the art.

An individual user of the computer device 106 can actuate a user input device of the computer device 106, such as a mouse or keyboard, to select a web page link in the displayed email message such that a browser application 134 operating in the computer device 106 is automatically executed. In response to the selection of the web page link in the displayed email message, the browser application 134 follows the selected web page link pointing to a web page on an information processing system communicatively coupled with the computer network 104. The process of a browser application 134 following a user-selected web page link pointing to a web page on an information processing system on a computer network 104 is well known to those of ordinary skill in the art.

The browser 134 receives a copy of the pointed to web page that is served up across the network 104 by the web server 124. Then, in response, the browser 134 displays displayable information from the received web page on the display screen 137 of the user interface 136.

The displayed web page, in the current example, includes displayable user information which is visibly displayed on the display screen in the user interface 136 as shown in FIG. 1. The displayed user information includes permanent swap ticket for voucher details 138 that was stored in a ticket record 116, 118, 120, in a ticket inventory database 114 in the flight ticket management server 102. The displayed user information, according to the example, also includes local seller ticket swap data 422 that was stored in the local storage memory repository 130 in the computer device 106. This local seller ticket swap data 422 was previously transmitted by the computer device 106 in the Automatic Response payload information (e.g., the message information transported by the Automatic Response) to the flight ticket swap process controller 122.

At least one user-selectable user interface element 143, 144, 145, 146, is also displayed on the display 137 of the user interface 136. Each of the at least one user-selectable user interface element, for example, may comprises one or more displayed icons that convey a selectable button, check-box, or the like. The user of the computer device 106 can select the particular at least one user-selectable user interface element and receive visual feedback on the display screen that the user's selection was accepted by the computer device 106. The user selection of the at least one user-selectable user interface element is a process that is well known to those of ordinary skill in the art. In response to user selection of an icon 146 to indicate that the user's manual selection is complete, the user selection of the at least one user-selectable user interface element can be entered into the ticket record 116 in the flight ticket inventory database 114. This seller's manual selection of an icon 146 is a manual response selected by the individual user (Seller) to complete and confirm the current permanent seller offer details 510 stored in the ticket record 116 in the flight ticket inventory data base 114. The flight ticket management server 102 can update the particular inventory record 116 in the inventory database 114 based on the seller's manual selection of the icon 146 which is a manual response selected by the individual user (Seller) to complete and confirm the current permanent seller offer details 510.

The updates to the ticket record 116 in the flight ticket inventory database 114 may take different forms based on the selections made by the individual seller user while accessing the web page on the information processing system. These various updates to the permanent seller swap offer details stored in the ticket record 116 in the database 114 will discussed in more detail below.

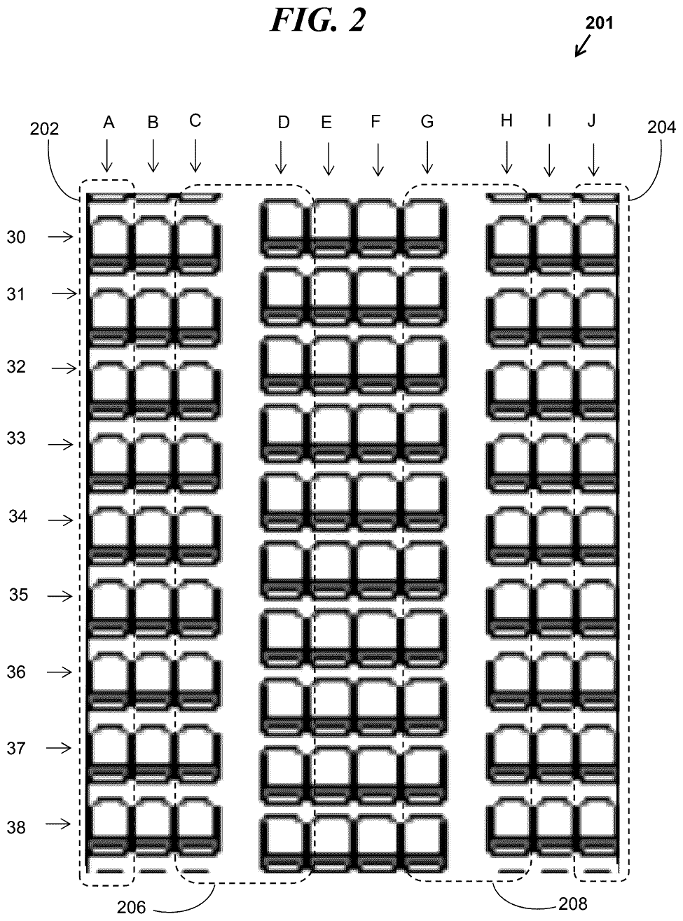

FIG. 2 illustrates an example of a seating map for a portion of an airplane. The seats shown are arranged in typical rows and columns. A purchaser of a flight ticket on that airplane can usually select a seat location on the flight associated with the flight ticket. The seat location can be identified by column and row. Seat locations near windows 202, 204 would be specified on the flight ticket by columns A or J, followed by a row number. In this example, the row numbers would be 30 to 38. Seat locations 206, 208, that are adjacent to an aisle on the airplane would be specified on the flight ticket by columns C, D, G, and H. There are many variations of identified seat assignments on an airplane, which can vary from airline to airline. For example, and not for limitation, seats in the front of the seating section such as in row 30 might be identified for seating selection. Similarly, seats in the last row of the seating section such as in row 38 might be identified for seating selection. As another example, seats located in a certain section of an airplane seating plan might be identified for seating selection, such as first class section, coach section, and the like. Some examples might be identified by certain features of the airplane, including the front of the airplane section, over a wing of an airplane seat location, rear of the airplane seat location, and a bulkhead seat location. There are many different ways to identify seating assignments on an airplane's seating plan. Each group of similar seating assignments, such as described by the non-limiting examples above, can also be referred to here as a class, a seating class, or a flight ticket class, and the like.

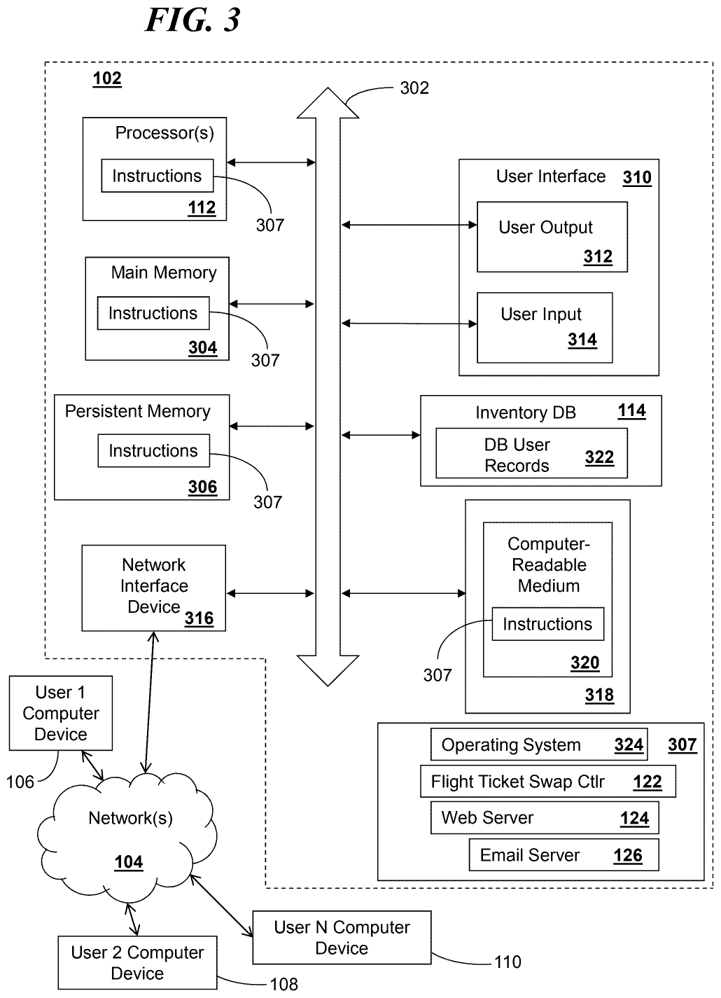

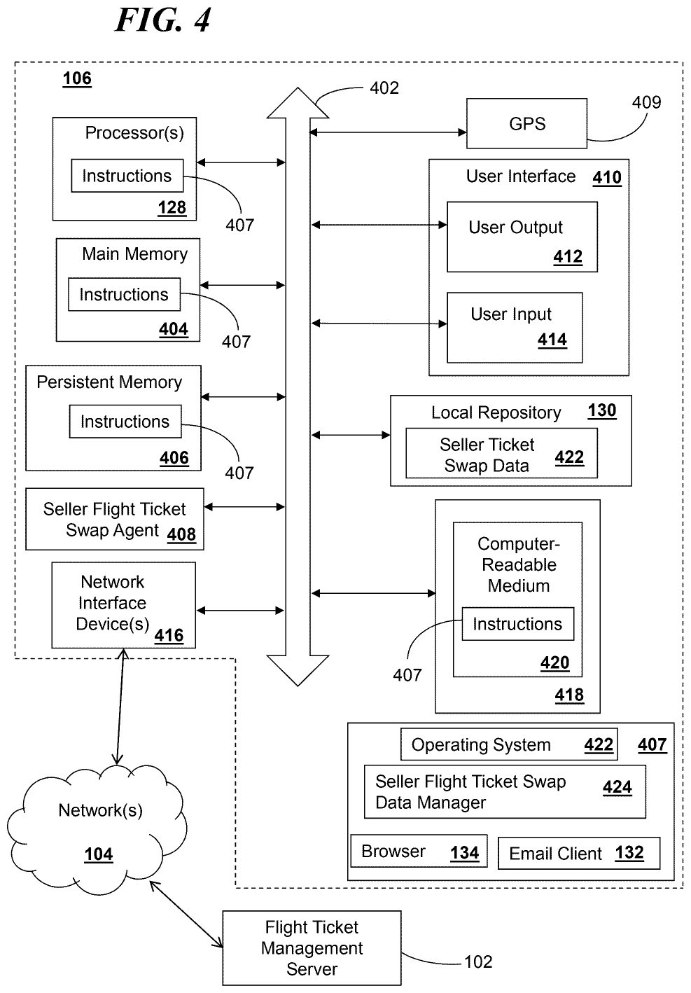

FIG. 3 illustrates a more detailed view of the flight ticket management server 102 which has been discussed above with reference to FIG. 1. FIG. 4 illustrates a more detailed view of the computer device 106 which has been discussed above with reference to FIG. 1.

While the present discussion is generally directed toward embodiments of a system and method for processing swaps of tickets for airplane flights from sellers of previously purchased tickets, the discussions herein are similarly applicable more generally to processing swaps of tickets for commercial carrier trips from sellers of previously purchased tickets. It should be noted that, according to various embodiments, the flight ticket management server 102 can more generally be discussed herein as being a commercial carrier ticket management server communicatively coupled with a passenger ticket database system comprising a multiplicity of commercial carrier ticket records associated with a respective multiplicity of tickets each associated with at least one person's reserved trip on a commercial carrier.

Moreover, according to various embodiments, the discussions herein are similarly applicable more generally to processing swaps of tickets for going somewhere, such as to be a guest of any one of a hotel, or a guest of a club's facilities, or a guest of a short-term and long-term homestay available from a service provider such as Airbnb, or the like, from sellers of previously purchased tickets.

Regarding FIG. 3, an example of an information processing system suitable for use as the flight ticket management server 102 includes various components. At least one processor 112 executes instructions 307 that cause the information processing system 102 to perform operations according to various embodiments of the invention. The processor 112, in this example, is communicatively coupled with various other components of the information processing system 102 via a system bus 302. Main memory 304 contains instructions 307, which can include computer instructions, configuration parameters, and data used by the processor 112. Persistent memory 306 can store the instructions 307 in persistent storage for the processor 112.

The processor 112, in this example, is also communicatively coupled with a user interface 310, which may include a user output interface 312 and a user input interface 314, and with a network interface device 316.

The user interface 310 includes a user output interface 312 and a user input interface 314 for communicating with the user (e.g., an operator or other technical personnel) using the information processing system 102. The user output interface 312 includes various output devices, such as a computer display device, indicator lights, a speaker that generates sound output to a user, or a data output interface device that can provide data and control signals to a user that comprises a computer system.

The user input interface 314 can include various input devices such as a computer keyboard, mouse device, touch screen display, a microphone that receives sound input signals from a user. The received sound signals, for example, can be converted to an electronic digital representation and stored in memory, and optionally can be used with voice recognition software executed by the processor 112 to receive user input data and commands. The user input interface 314 can include a data input interface device (not shown) that can receive data and control signals from a user that comprises a computer system.

The network interface device 316 is communicatively coupled with the processor 112 and provides a communication interface for the information processing system 102 to communicate via one or more networks 104. The networks 104, as has been discussed above with reference to FIG. 1, can include wired or wireless networks or a combination of both, and can be any of local area networks, wide area networks, or a combination of such networks. For example, wide area networks, including the Internet and the web, can inter-communicate the information processing system 102 with other information processing systems that may be locally or remotely located relative to the information processing system 102. It should be noted that mobile communications devices, such as mobile phones, Smartphones, tablet computers, lap top computers, and the like, which are capable of at least one of wired or wireless communication, are also examples of information processing systems and are also examples of the computer devices 106, 108, 110, within the scope of the present disclosure.

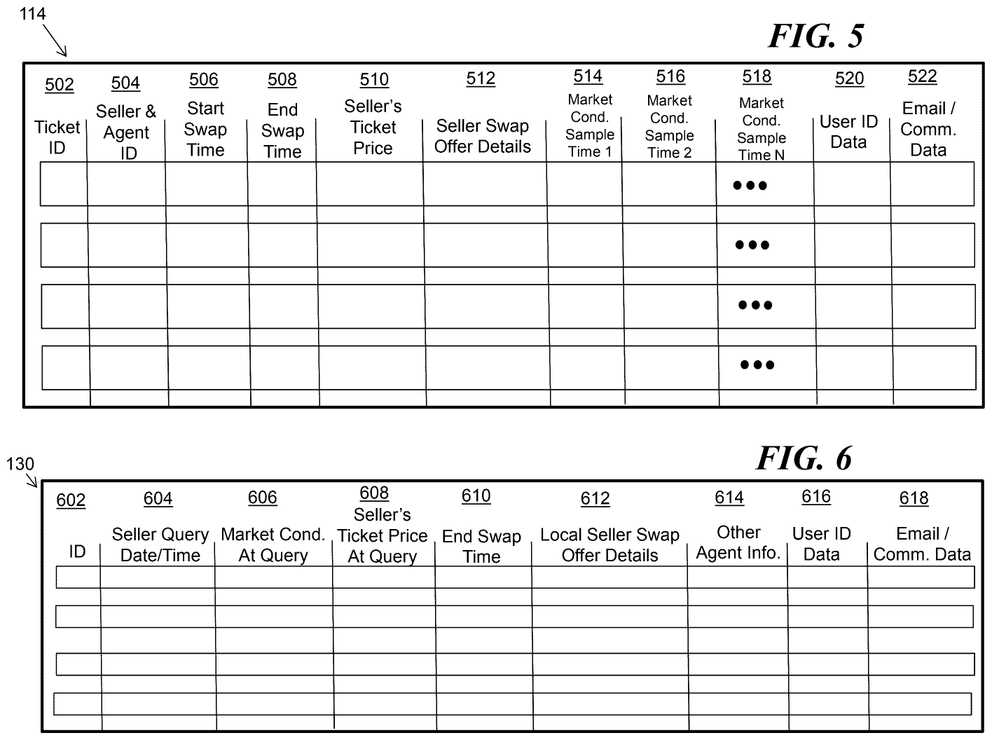

Flight ticket inventory database 114, according to various embodiments, can include a database (collection) of ticket records 116, 118, 120, and a database (collection) of user records 322. In certain embodiments, flight ticket inventory database 114 can include a database of user records 322. That is, flight ticket inventory records 116, 118, and 120, can include seating information and user information associated with each passenger and seat on a particular flight. A more detailed example of the flight ticket inventory database 114 is shown in FIG. 5, which will be discussed more fully below.

The instructions 307, which can include computer instructions, configuration parameters, and data, can be stored in the computer-readable medium 320, the main memory 304, the persistent memory 306, and the processor's internal memory such as cache memory and registers.

Instructions 307, according to various embodiments, can include an operating system 324, a flight ticket swap controller 122, a web server 124, and an email server 126. The flight ticket swap controller 122 interoperates with the processor 112 to cause the flight ticket management server 102 to operate according to various novel methods that are disclosed herein. Some of the operations have been described above with reference to the example of FIG. 1, in which the flight ticket management server 102 can automatically send repeated Query Messages to each of the plurality of computer devices 106, 108, 110, and thereby possibly receive updates to the flight ticket inventory records 116, 118, 120, in the flight ticket inventory database 114. The records 116, 118, 120, are updated to accurately reflect the current swap offer details of each individual user (Seller) associated with the respective each computer device 106, 108, 110. The various elements of the instructions 307 will be discussed in more detail below.

FIG. 4 illustrates an example information processing system 106 suitable for use as the computer devices 106, 108, 110. Examples of various components of the computer devices are also shown. The at least one processor 128 executes instructions 407 that cause the information processing system 106 to perform operations according to various embodiments of the invention. The processor 128, in this example, is communicatively coupled with various other components of the information processing system 106 via a system bus 402. Main memory 404 contains instructions 407, which can include computer instructions, configuration parameters, and data used by the processor 128. Persistent memory 406 can store the instructions 407 in persistent storage 406 for the processor 128.

The processors 128 is communicatively coupled via the system bus 402 with a seller flight ticket swap agent 408, which will be discussed in more detail below, and with the network interface device 416. The network interface device 416 is also communicatively coupled with the networks 104 which provide a path of communication between the user computer device 106 and the flight ticket management server 102.

The networks 104, which have also been discussed above with reference to FIG. 1, can include wired or wireless networks or a combination of both, and can be any of local area networks, wide area networks, or a combination of such networks. For example, wide area networks, including the Internet and the web, can inter-communicate the information processing system 106 with other information processing systems that may be locally or remotely located relative to the information processing system 106. It should be noted that mobile communications devices, such as mobile phones, Smartphones, tablet computers, lap top computers, and the like, which are capable of at least one of wired or wireless communication, are also examples of information processing systems and are also examples of the computer devices 106, 108, 110, within the scope of the present disclosure.

In certain embodiments, the processor 128 can be communicatively coupled with a GPS module 409 which provides location information to the processor 128. The processor 128 can use the location information in various applications running in the user computer device 106.

A user interface 410 includes a user output interface 412 and a user input interface 414 for communicating with the user of the information processing system 106. The user output interface 412, for example, includes various output devices, such as a computer display device, indicator lights, a speaker that generates sound output to a user, or a data output interface device that can provide data and control signals to a user that comprises a computer system.

The user input interface 414, for example, can include various input devices such as a computer keyboard, mouse device, touch screen display, a microphone that receives sound input signals from a user. The received sound signals, for example, can be converted to an electronic digital representation and stored in memory, and optionally can be used with voice recognition software executed by the processor 128 to receive user input data and commands. The user input interface 414 can include a data input interface device (not shown) that can receive data and control signals from a user that comprises a computer system.

In certain embodiments, a short-range wireless transceiver (not shown) is communicatively coupled via the system bus 402 to the processor 128. The processor 128 can interoperate with the short-range wireless transceiver, according to various embodiments, to receive from, and transmit information signals to, (e.g., via Bluetooth or via WiFi) wireless transceivers in various types of devices located proximate to, e.g., in a local vicinity of, the computer device 106.

A flight ticket swap seller data repository 130, which can also be referred to as a local repository 130, stores a collection of seller ticket swap data 422 in the user's computer device 106. Seller ticket swap data 422 can be used by the seller flight ticket swap agent 408 to track ticket swap data associated with a seller user of the computer device 106. That is, when a user of computer device 106 is a seller of a previously purchased flight ticket, the seller ticket swap data 422 is maintained and updated, as necessary, during a swap ticket process. Seller flight ticket swap agent 408, according to various embodiments, comprises software instructions residing in memory in the computer device 106. The flight ticket swap agent 408 interoperates with the one or more processors 128 and is communicatively coupled with the local data repository 130. The flight ticket swap agent 408 thereby can access the seller ticket swap data 422 during a swap ticket process for a seller who is a user of the computer device 106. The seller flight ticket swap data manager 424 maintains and updates seller ticket swap data 422 in the local repository 130.

The computer readable medium 420 removably stores the instructions 407, in various embodiments, via a read-and-write hardware interface device 418. The user can selectively remove from, or install in, the computer device 106 the computer readable medium 420 via the read-and-write hardware interface device 418. A more detailed example of the local storage memory repository 130 is shown in FIG. 6, which will be discussed more fully below.

As illustrated in FIG. 4, the instructions 407 can include an operating system 422, the seller flight ticket swap data manager 424, the browser 134, and the email client 132.

The seller flight ticket swap data manager 424 and the seller flight ticket swap agent 408 interoperate with the processor 128 to cause the computer device 106 to operate according to various novel methods that are disclosed herein. Some example operations have been described above with reference to the example system 100 of FIG. 1. For example, the computer device 106 can receive user input information from a user of the device and store the information as part of the local seller ticket swap data 422 stored in the local storage memory repository 130 of the computer device 106. The seller flight ticket swap agent 408 can receive a user request to change information in the local seller ticket swap data 422. For example, the user might want to change some of the data in the current seller swap offer details 612, as will be discussed below with reference to FIG. 6.

The computer device 106 while in a flight ticket swap process can repeatedly receive, e.g., during a day or several days, Query Messages from the flight ticket management server 102 and continuously update information in the local seller ticket swap data 422 stored in the local storage memory repository 130. For example, a status of the seller's flight ticket in the flight ticket swap process can be updated in the local seller ticket swap data 422, based on the information received in the Query Messages from the flight ticket management server 102. Additionally, the seller swap ticket agent 408 running in the computer device 106 can receive from the user (Seller) a request to review the current status of the flight ticket in the flight ticket swap process at the time of the most recently received Query Message from the flight ticket management server 102.

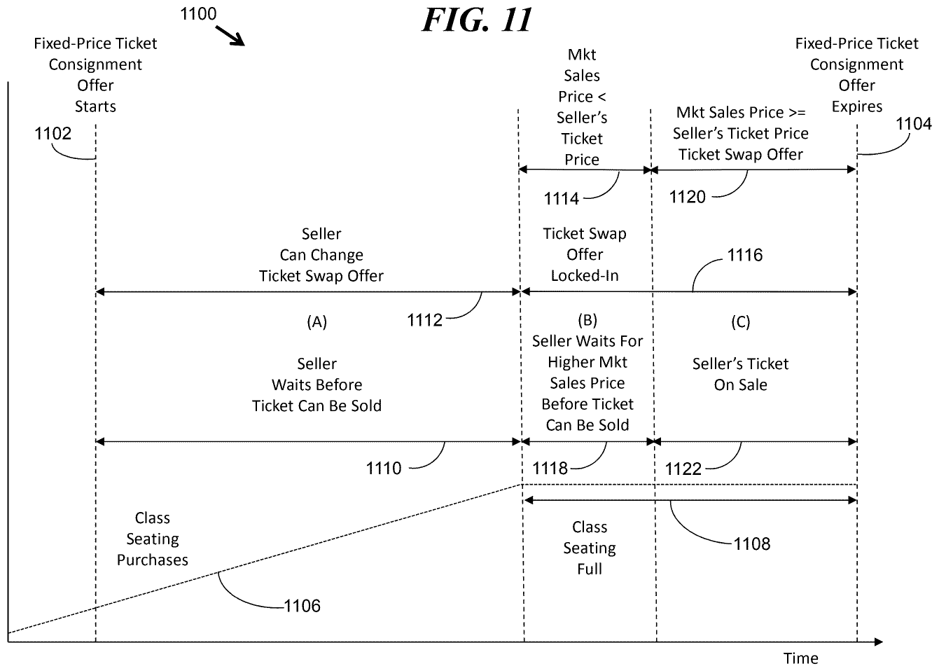

If the user (Seller) operates the seller swap ticket agent 408 to make a permitted change to the current seller swap offer details 612 (see FIG. 6) which are permanently stored in the ticket record 116 in the flight ticket inventory database 114, the seller swap ticket agent 408 updates the information in the seller ticket swap data 422 to communicate to the flight ticket management server 102 at the next time the computer device receives the Query Message from the flight ticket management server 102 that the Seller wants to make a change to the current seller swap offer details 612. It should be noted that not all change requests from a Seller user of the computer device 106 are permitted in the flight ticket swap process being followed by the flight ticket management server 102. More details of what changes are permitted and when they can be made during a flight ticket swap process are discussed below with reference to FIG. 11.

During repeated Query Messages between the flight ticket management server 102 and each of the plurality of computer devices 106, 108, 110, the flight ticket management server 102 sends a query email message to each computer device 106, 108, 110, and receives an Automatic Response transmitted by each computer device 106, 108, 110, in response to receiving its respective Query Message. The Automatic Response, from each computer device, includes the individual user's local seller ticket swap data 422, including any request for change received from the user by the seller ticket swap agent 408 which was collected and stored in the local storage memory repository 130 of the individual user's computer device 106, 108, 110, since the last time a Query Message was received by the computer device. The individual user's local seller ticket swap data 422 received by the flight ticket management server 102 from each of the computer devices can include the computer device's determination of the individual user's request for a change to the current seller swap offer details 612, which will be permanently stored in the ticket record 116 in the ticket inventory database 114 after the request for change was manually confirmed by the Seller using the computer device 106, as will be discussed in more detail below.

FIG. 5 illustrates an example of the flight ticket inventory database system 114. Each row represents a ticket record 116, 118, 120. Each column represents various data and parameters stored in each of the ticket records 116, 118, 120.

Each ticket record in the ticket inventory database 114 can include a ticket ID field 502 which uniquely identifies the ticket record in the database 114. Seller and agent identification information 504 is maintained in each ticket record to identify specifically the seller user of the computer device 106 and the seller flight ticket swap agent 408 representing the seller user during the swap ticket process. Time information indicating when a swap ticket process started 506 and when the swap ticket process will end 508 is also maintained in each ticket record 116.

Current seller swap offer details information 510 is stored in each ticket record. The current seller swap offer details 510 indicate how the seller of the flight ticket associated with the ticket record is selling (swapping) the flight ticket with the airline and how the seller will be compensated for the sale.

During a swap ticket process, the current market price conditions associated with the flight ticket are periodically sampled and at each sample time the time information and the market price conditions are stored 514, 516, 518, in the flight ticket record 116. This way, the flight ticket swap process controller 122 tracks the varying market price conditions associated with the seller's flight ticket. Each ticket record 116, 118, 120, stores user identification information 518 for the seller who is the user of the computer device 106. Each ticket record 116, 118, 120, stores email address information and network communication information 520 which can be used by the flight ticket swap process controller 122 to communicate with the user computer device 106.

FIG. 6 illustrates an example of the flight ticket swap seller data repository 130, which also can be referred to here as the seller data repository 130, the local data repository 130, and the like, as one clearly understands from the context of the specific discussion herein. Each row in the data repository 130 represents a current snapshot of the seller's flight ticket swap process data and parameters maintained in data repository 130. Periodically, the flight ticket swap process controller 122 sends a query to the user computer device 106 to determine a possible change of the data and parameters maintained in the local data repository 130. Each row in the data repository 130 represents a current snapshot at the time of the latest Query Message sent from the flight ticket swap process controller 122 in the flight ticket management server 102.

Each column represents data and parameters stored in a snapshot of the seller's flight ticket swap process in the local data repository 130 contemporaneous with the time that the user computer device 106 received the Query Message from the flight ticket swap process controller 122, and any changes locally requested by the user of the computer device 106 since the last Query Message was received by the computer device. A locally requested change, in the computer device 106, can become a permanent change, in the ticket record 116 in the inventory database 114, after the user manually confirms the request with the flight ticket management server 102. The user manual confirmation of the request for change is performed at the flight ticket management server 102 after the computer device 106 has received the next Query Message and has sent the Automatic Response to the flight ticket management server 102.

In certain embodiments, the Automatic Response may include an information field indicating a status of the user's current use of the computer device 106 contemporaneous with receiving the Query Message. For example, this information field can inform the server 102 whether the user is currently using the computer device 106 and the user's manual confirmation response (e.g., via a web page at the flight ticket management server 102) can be expected soon. If the information field informs the server 102 the user is currently not using the computer device 106, this can indicate that the user's manual confirmation response (e.g., via the web page) will likely be delayed for some time. This can additionally indicate that the individual user is currently not in close proximity to (e.g., not present at) the computer device 106. That is, the information field in the Automatic Response informs the server 102 that the individual user's change request in the Automatic Response may not be current or accurate. It flags a condition of uncertain query response information being received in the Automatic Response. The flight ticket management server 102 in response to receiving the Automatic Response including the information field, can check the information field to determine whether the seller is using the respective seller's user computer device contemporaneous with receiving the Query Message. If the flight ticket management server 102, based on the checking the information field, determines that the user's manual confirmation response (e.g., via the web page) will likely be delayed and may not be current or accurate, the server 102 can stop monitoring the web page for a user manual confirmation response, and alternatively the server 102 proceeds to send Query Messages to other seller users of computer devices 108, 110. The server 102 can later send another Query Message to the particular seller's user computer device 106. This processing to determine whether a seller is using the respective seller's user computer device 106, increases speed and efficiency of the server 102 sending a large number of Query Messages, and receiving both the associated Automatic Responses and the manual confirmations from a large number of sellers using a large number (multiplicity) of seller user computer devices 106, 108, 110. The user manual confirmation process will be discussed further below.

Each snapshot includes a snapshot ID 602 which uniquely identifies the snapshot stored in the local data repository 130. The snapshot includes a seller query date and time information 604. This time information 604 represents a current time when the user computer device 106 received the latest query message from controller 122. Each snapshot also includes information indicating the current market price condition 606 related to the seller's flight ticket at the time of receiving the latest query message from controller 122. The snapshot also includes the seller's current flight ticket price 608 at the time of the query message received from the controller 122. The seller's current flight ticket price 608 is the current price of the seller's flight ticket agreed to by the seller according to a flight ticket consignment agreement tracked by the flight ticket management server 102.

Each snapshot stored in the local data repository 130 also includes time information representing the end time 610 of the seller's swap ticket process. The end time 610 is specific to the flight ticket consignment agreement with the seller. For example, and not for limitation, the end time 610 can be set to 24 hours before the flight time of the airplane associated with the seller's flight ticket. As another example, the end time 610 could be set to one hour before the flight time. The end time 610 can be set to any other time before the flight time associated with the seller's flight ticket.

Each snapshot includes local seller swap offer details information 612 stored in the local data repository 130. The seller flight ticket swap agent 408, according to various embodiments, can update the local seller swap offer details information 612 in response to user input received from the seller user of the computer device 106. However, an update to the local swap offer details 612 is updated in the ticket record 116 in the flight ticket inventory database system 114 only after a next Query Message from the flight ticket swap process controller 122 is received at the user computer device 106, in response thereto an Automatic Message is sent from the computer device 106 to the server 102, and the user request for a change manually confirmed to the flight ticket management server 102 by the seller user of the computer device 106, as will be discussed more fully below.

Each snapshot can also include other agent information 614 used and updated by the seller flight ticket swap agent 408 during the flight ticket swap process. The snapshot can also include user identification information 616 and email and communication data 618 which can be used by the user computer device 106 to communicate over the network 104 with the flight ticket management server 102.

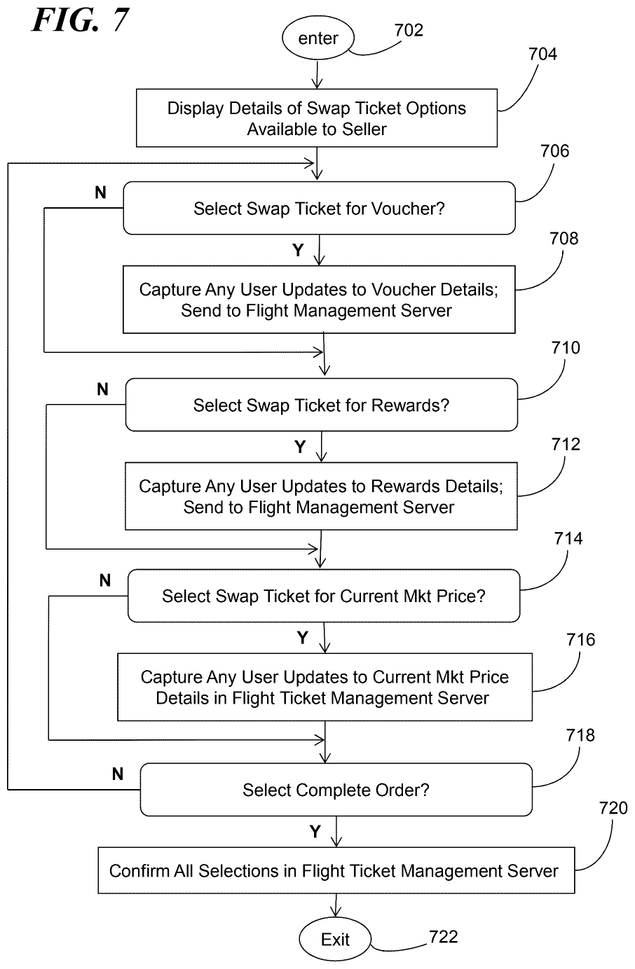

An example set of operations in the flight ticket swap system 100 will be discussed below referring to the flow diagrams in FIG. 7 to FIG. 10 and the timing diagram in FIG. 11.

Referring to FIG. 7, after a seller user of the computer device 106 clicks a link provided in a Query Message received by the computer device (which is after the computer device 106 has sent the Automatic Response to the flight ticket management server 102), the processor 112 enters, at step 702, the set of operations and immediately proceeds to display user information and options on the web page. The user information and options are displayed in the user interface 136 and the user output interface 137 to a user of the computer device 106. Processor 112, at step 704, displays via the web page and thereby in the user output interface (display) 137 messages and prompts that guide the user of the computer device 106 to manage their bookings with the airline and particularly to access a lookup of a swap ticket function at the flight ticket management server 102 associated with the airline. The processor 112 in the flight ticket management server 102 causes display 137 of the details of the swap ticket program as applicable to the user of the computer device 106.

The user output interface (display) 137 displays details of the swap ticket program available to the user as shown in the example of FIG. 1. The user of the computer device 106, in this example, is not able to use their flight ticket for a particular flight in the future. The user output interface 137 displays options available to the user if they want to swap their flight ticket with the airline to sell on consignment to a buyer of the flight ticket, under certain conditions. In return for the user (Seller) selling their flight ticket through the airline on consignment, the airline would compensate the seller (user) certain value as will be discussed below.

One option for the user is to swap their flight ticket with the airline and in exchange the airline would provide a voucher to the seller of the flight ticket. The voucher would have a cash value of a percentage of the original price paid by the seller for the purchase of the flight ticket. The voucher can be provided to the airline by the seller toward a purchase of another flight ticket in the future, or exchanged for cash value. For example, a voucher could have a value of 80% of the original price of the flight ticket paid by the seller. As a second example, a voucher could have a value of 50% of the original price paid by the seller for the flight ticket. The value of the voucher could be set to any percentage of the original price of the flight ticket that is agreed to by the seller of the flight ticket and the airline. The swap ticket for voucher offer 138 is displayed in detail on a web page and thereby on a display device of the user output interface 137, which should be visible on the computer device 106. If the seller is interested in the voucher offer 138 one or more selectable swap for voucher display elements 143 can be selected by the user of the computer device 106 to manually confirm the selection of this option.

Moreover, according to various embodiments as will be more fully discussed below, the displayed voucher offer can include a display of the seller swap offer details 512 stored in the permanent ticket record 115 in the inventory database 114. This permanent record of the seller swap offer details 512 is indicated in FIG. 1 by the symbol “P” in the selectable display element 143. The user can select the symbol “P” to manually confirm that the permanent record of the seller swap offer details is the correct version.

The voucher offer 138 can also include a display of a local version of the seller swap offer details 612 stored in the local data repository 130 in the computer device 106. The local version of the seller swap offer details 612 may have been changed by the user of the computer device 106 since a last most recent time a Query Message was received, and after an Automatic Response was sent to the flight ticket management server 102, by the computer device 106. The local record version of the seller swap offer details 612 is indicated in FIG. 1 by the symbol “L” in the selectable display element 143. The user can select the symbol “L” to manually confirm that the local record of the seller swap offer details is the correct version. With the “L” symbol having been selected, the flight ticket management server 102 will update the permanent record of the seller swap offer details 512 with the local version of the seller swap offer details 612 which includes changes to the local version in the seller swap ticket data 422 stored in the local data repository 130 which were previously made by the user of the computer device 106, since a last most recent time a Query Message was received, and after an Automatic Response in response to the Query Message was sent to the flight ticket management server 102.

A second option available to the user is to swap their flight ticket with the airline and in exchange the airline would provide certain rewards. For example, the rewards could be in airline miles that can be used by the seller in the future toward being eligible for certain benefits. The details of this swap ticket for rewards offer 140 are displayed on the display device of the user output interface 137, which should be visible on the computer device 106. If the seller is interested in the rewards offer 140, one or more selectable swap for rewards display elements 144 can be selected by the user of the computer device 106 to manually confirm the selection of this option.

Moreover, according to various embodiments as will be more fully discussed below, the displayed rewards offer can include a display of the seller swap offer details 512 stored in the permanent ticket record 115 in the inventory database 114. This permanent record of the seller swap offer details 512 is indicated in FIG. 1 by the symbol “P” in the selectable display element 144. The user can select the symbol “P” to manually confirm that the permanent record of the seller swap offer details is the correct version.

The rewards offer 140 can also include a display of a local version of the seller swap offer details 612 stored in the local data repository 130 in the computer device 106. The local version of the seller swap offer details 612 may have been changed by the user of the computer device 106 since a last most recent time a Query Message was received, and after an Automatic Response was sent to the flight ticket management server 102, by the computer device 106. The local record version of the seller swap offer details 612 is indicated in FIG. 1 by the symbol “L” in the selectable display element 144. The user can select the symbol “L” to manually confirm that the local record of the seller swap offer details is the correct version. With the “L” symbol having been selected, the flight ticket management server 102 will update the permanent record of the seller swap offer details 512 with the local version of the seller swap offer details 612 which includes changes to the local version in the seller swap ticket data 422 stored in the local data repository 130 which were previously made by the user of the computer device 106, since a last most recent time a Query Message was received, and after an Automatic Response in response to the Query Message was sent to the flight ticket management server 102.

Other options might be made available to the seller by the airline which would be displayed on the user output interface 137 and manually confirmed being selected by the user selecting a selectable display element displayed on the user output interface 137. For example, a third option is displayed in the display element 142 and can be manually confirmed by the user selecting the associated one or more selectable display elements 145.

For example, the third option shown in FIG. 1 is displayed in detail as a swap ticket at the current market price 142. It's associated selectable one or more display elements 145 confirms the selection of the swap ticket for the current market price. The selectable one or more display elements 145 in the example include the symbols “P” and “L” that can each be selected by the user of the computer device 106 to manually confirm the seller's selection of either the permanent record version of the seller swap offer details 512 or the local version of the seller swap offer details 612 which includes changes to the local version in the seller swap ticket data 422 stored in the local data repository 130. This third option will be discussed in more detail below with reference to FIG. 11. According to certain embodiments, more than one displayed option could be selected by the user by selecting multiple selectable display elements displayed on the display device 137.

Referring again to FIG. 7, processor 112 checks, at step 706, if the one or more display elements 143 to select swap ticket for voucher have been selected. If selected, at step 706, then the processor 112 will capture any updates to swap for voucher details and stores the information in a ticket record 116 in the database 114 of the flight ticket management server 102. It should be noted that in the example, if neither the “P” or “L” symbol are selected, the default permanent record stored in the ticket record 116 remains unchanged.

If the one or more display elements 143 are not selected, at step 706, the processor 128 checks, at step 710, if the swap ticket for rewards one or more display elements 144 have been selected. If selected, at step 710, the processor 112 captures any updates to the swap for rewards details 140 and stores the information in the ticket record 116 in the ticket inventory database 114 in the flight ticket management server 102. If not selected, at step 710, processor 112 continues to check other options being selected. It should be noted that in the example, if neither the “P” or “L” symbol are selected, the default permanent record stored in the ticket record 116 remains unchanged.

One option 142 available to the Seller, in the example, is to swap their flight ticket at the current market price of the flight ticket, which might be lower than the original price paid by the Seller for the flight ticket. The current market price can be displayed in the web page and thereby displayed in the option details 142. The processor 112, at step 714, checks whether a swap ticket for the current market price option 142 has been selected by the user of the computer device by detecting a selection of one or more selectable display elements 145, as has been discussed above. If selected, in step 714, processor 112 captures any updates to the swap for current market price details and stores the information in the ticket record 116 in the ticket inventory database 114 in the flight ticket management server 102. The seller's ticket price 510 in the ticket record 116 can be changed to a lower current market price of the flight ticket. However, according to various embodiments, if the flight management server 102 determines that the current market price is higher than the original price paid for the flight ticket, the option to swap their flight ticket at the current market price of the flight ticket will not be available to the Seller and accordingly will not be displayed on the web page.

If not selected, at step 714, the processor 112 checks, at step 718, whether the user's selections have been completed and confirmation of the order of all the selections is given by the user's manual selection of the selectable display element 146. While the display element 146 has not been manually selected thereby indicating selection of all options and confirmation of order is not completed, at step 718, the processor 112 continues to check selections and updates to the displayed options on the web page which is displayed on the user output interface 137. When the selectable display element 146 is selected by the user of the computer device 106, the user has manually confirmed that the order is complete, at step 718, and the processor 112, at step 720, confirms all the selections and any updates are stored in the permanent ticket record 116 in the inventory database 114 in the flight ticket management server 102, and then exits the operational sequence, at step 722.

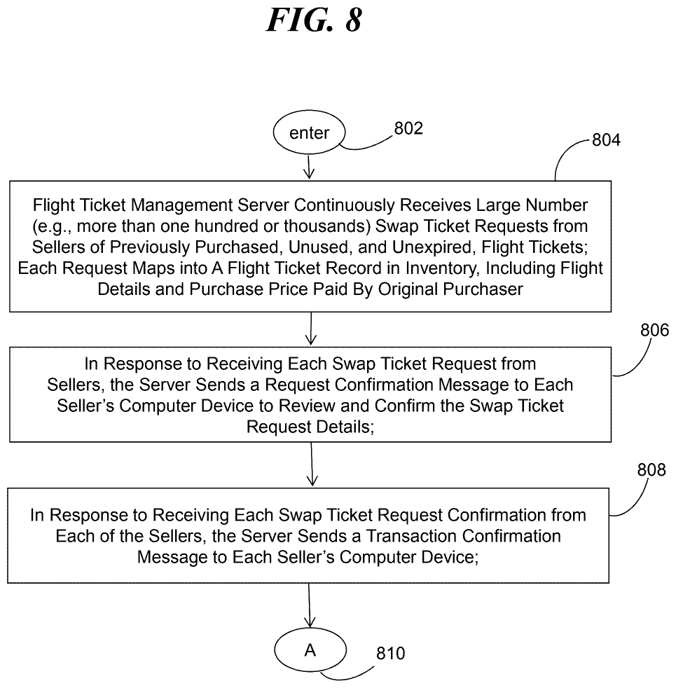

The operations described below with reference to FIG. 8, in the example, include continuous exchanges of messages between the flight ticket management server 102 and a multiplicity of seller user's computer devices 106, 108, 110, requesting to swap their flight tickets with the airline computer system 100. Referring specifically to FIG. 8, processor 112 of the flight ticket management server 102, enters the operational sequence, at step 802, and immediately proceeds to continuously receive, at step 804, a multiplicity (very large numbers) of swap ticket request messages from sellers of previously purchased unused and unexpired flight tickets. For example, the processor 112 can be contemporaneously receiving from the networks 104 more than 100, or possibly more than 1000, swap ticket requests, and processing the swap ticket requests in near real-time. These swap ticket requests can be received, according to one example, by remote users with the computer devices 106, 108, 110, accessing the flight ticket management server 102 as an online portal and thereby entering their requests into the flight ticket management server 102. These swap ticket requests can be received by the flight ticket management server 102, according to a second example, by remote users with their computer devices 106, 108, 110, transmitting email messages (or other types of messages such as via SMS, MMS, or RCS) via one or more networks 104 destined for reception by the flight ticket management server 102 as an online messaging server and thereby entering their requests into the flight ticket management server 102. Any combination of different methods for sending requests to the flight ticket management server 102 thereby requesting to swap flight tickets with the airline are anticipated by the above discussion and some examples. Each such swap ticket request is mapped by the processor 112 into one of the ticket records 116, 118, 120, in the flight ticket inventory database system 114.

In response to receiving each swap ticket request from sellers, at steps 806, flight ticket management server 102 sends a request confirmation message to each seller's computer device 106 which prompts the user of the computer device 106 to review and confirm the swap ticket request details. The request confirmation message can be sent to the computer device 106 in many different ways, and using different messaging protocols and/or message formats.

In response to receiving each swap ticket request confirmation message from each of the seller's computer device 106, at step 808, the flight ticket management server 102 sends a transaction confirmation message to the seller's computer device 106. Each seller user of a computer device 106, 108, 110, that has received the transaction confirmation message from the server 102 is notified that their flight ticket is now started in a flight ticket swap process with the flight ticket management server 102. Processor 112 then exits the operational sequence at step 810.

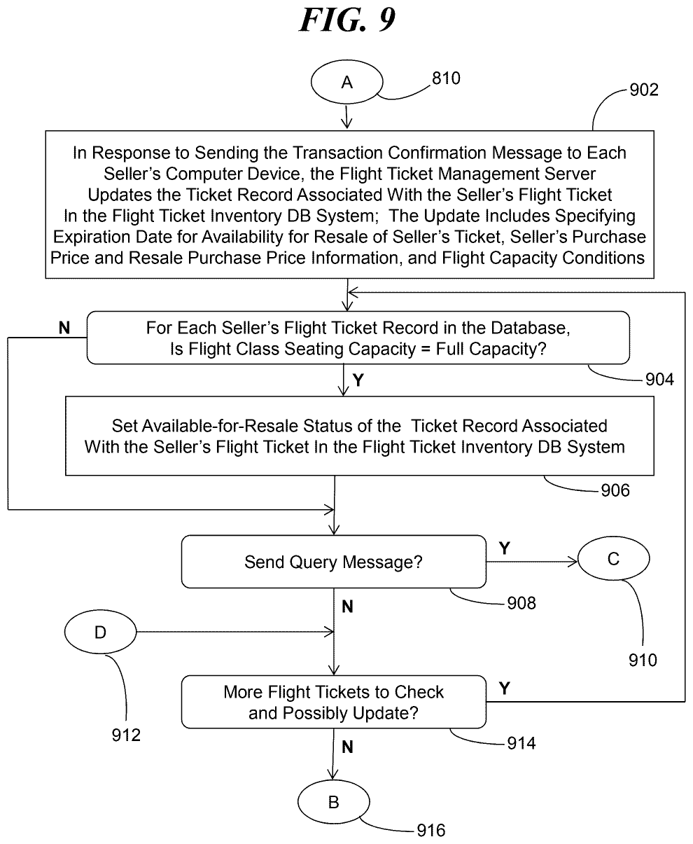

Referring to FIG. 9, the processor 112 of the flight ticket management server 102 enters the operational sequence at step 810, and immediately proceeds to step 902. In response to sending the transaction confirmation message to each seller's computer device 106, at step 902, the flight ticket management server 102 updates, in the flight ticket inventory database system 114, the ticket record 116 which is associated with the seller's flight ticket. The update of the ticket record, according to the example, can include updating the expiration date 508 for the availability of resale of the seller's flight ticket, and updating the seller swap offer details 512. Seller swap offer details 512 might include, for example, details of one or more of the swap options in the user interface 137 shown in FIG. 1, and discussed above. The seller swap offer details 512 have been stored in the ticket record 116 by the flight ticket management server 102 after establishing the flight ticket swap process with the seller via their computer device 106, such as discussed above with reference to FIG. 8.

The update to the seller swap offer details 512 can include, according to the example, an update to the seller's flight ticket price 510 which is referenced by the seller swap offer details 512 stored in the ticket record 116. The update to the ticket record 116 can also include an update to the current market resale price of the flight ticket 514 and an update to the class seating flight capacity conditions, which are maintained in the seller swap offer details 512 and the current market conditions information 514, 516, 518, stored in the ticket record 116 along with the current sample time information 514, 516, 518.

The processor 112, at step 904, checks each flight ticket record 116, 118, 120, to determine whether the flight class seating capacity has reached full capacity. If the flight class seating capacity has not reached full capacity for a ticket record, at step 904, then the processor 112, at step 908, checks the flight ticket record 116, 118, 120, to determine if it is time to send a Query Message to the remote computer device 106, 108, 110.

The Query Messages are sent based on the flight ticket management server 102 determining a time interval to allow between sending Query Messages to the same computer device 106, as well as the flight ticket management server 102 managing its computer resources to meet varying demands of a multiplicity of seller computer device 106, 108, 110 requests to swap flight tickets.

If the processor 112, at step 908, determines that it is not time to send a Query Message to a remote computer device 106, while there are more flight tickets to check and possibly update, at step 914, processor 112 checks flight class seating capacity conditions for another flight ticket record, at step 904.

If the flight class capacity has reached full capacity for a ticket record, at step 904, the processor 112 updates the ticket record to indicate that the flight ticket is available for resale, at step 906. Then the processor 112, at step 908, checks the flight ticket record 116, 118, 120, to determine if it is time to send a Query Message to the remote computer device 106, 108, 110. If the processor 112, at step 908, determines that it is not time to send a Query Message to a remote computer device 106, while there are more flight tickets to check and possibly update, at step 914, processor 112 checks flight class seating capacity conditions for another flight ticket record, at step 904.

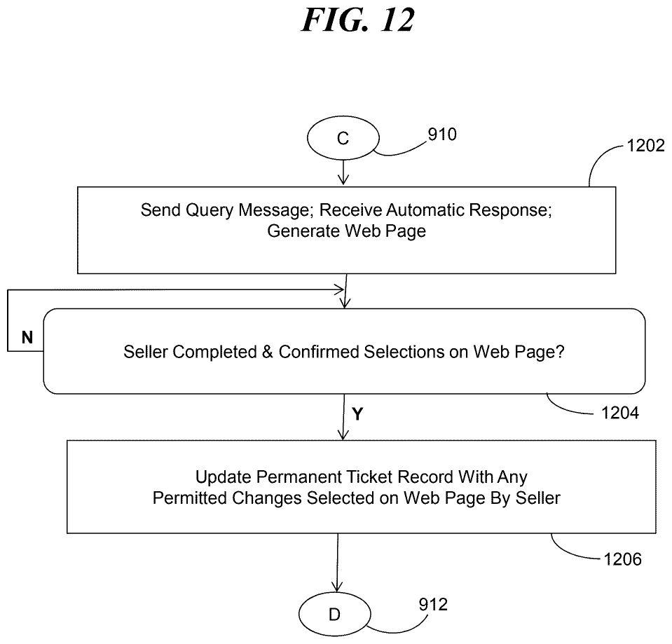

On the other hand, if the processor 112, at step 908, determines that it is time to send a Query Message to a remote computer device 106, then the processor 112, at step 910, immediately proceeds to send a Query Message, at step 1202. See also FIG. 12.

The processor 112, at step 1202, also receives the Automatic Response from the remote computer device 106, and generates the web page with the information from the permanent ticket record 116 and the information received in the Automatic Response from the remote computer device 106. The processor 112 continues to check, at step 1204, whether the seller completed and confirmed all selections in the web page, as has been discussed above with reference to FIG. 7. That is, for example, the processor 112 checks, at step 718, whether the user's selections have been completed and confirmation of the order of all the selections is given by the user's manual selection of the selectable display element 146.

When the selectable display element 146 is selected by the user of the computer device 106, the user has manually confirmed that the order is complete and the processor 112, at step 1206, confirms all the selections and any updates are stored in the permanent ticket record 116 in the inventory database 114 in the flight ticket management server 102. The processor 112 then proceeds, at steps 912, 914, to check if there are more flight tickets to check and possibly update.

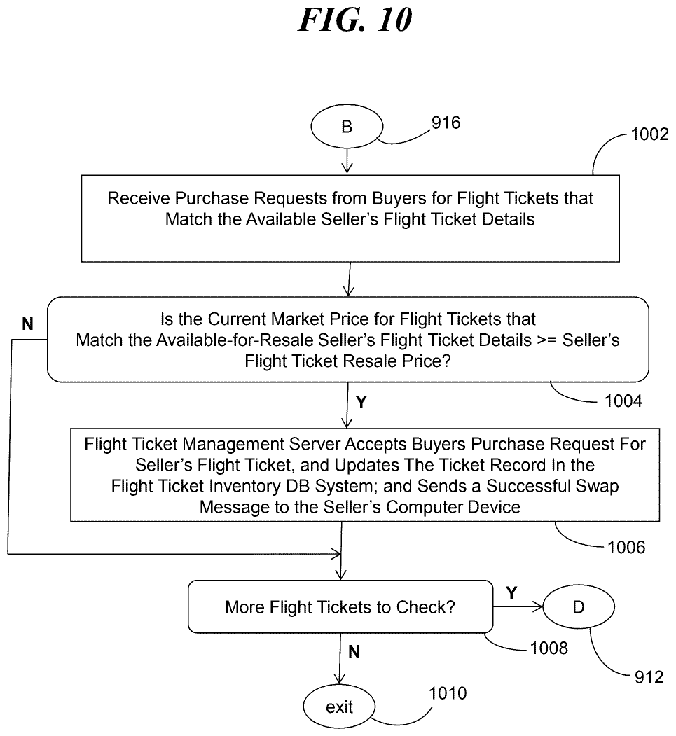

After all flight ticket records 116, 118, 120, in the current processing have been checked and possibly updated, at step 914, the processor 112 then continues the operational sequence at step 916. See also FIG. 10.

Referring specifically to FIG. 10, the processor 112 enters this operational sequence, at step 916, and immediately proceeds to receive purchase requests from buyers for flight tickets that match the available seller's flight ticket details, at step 1002. However, if the current market price for the seller's flight ticket is not at least equal to or greater than the seller's flight ticket sale price, at step 1004, the processor 112 continues checking other flight ticket records, at steps 1008, 912, 914. See also FIG. 9.

On the other hand, if the current market price for the seller's flight ticket is at least equal to or greater than the sellers flight ticket price, at step 1004, the processor 112 accepts a purchase request from a buyer for the sellers flight ticket, at step 1006, and updates the ticket record 116 in the flight ticket inventory database system 114 to indicate the flight ticket has been purchased by the buyer. The processor 112 also sends a successful flight ticket swap message to the seller's computer device 106 to notify the seller that the flight ticket has been successfully sold to a buyer. Based on the seller swap offer details 512 in the ticket record 116, at step 1006, the processor 112 can include in the successful flight ticket swap message a notification of a voucher in exchange for the flight ticket, a notification of rewards in exchange for the flight ticket, or any combination of a voucher and rewards in exchange for the flight ticket. The processor 112 continues checking other flight ticket records, at steps 1008, 912, 914, while there are more flight ticket records to check. When there are no more flight tickets to check, at step 1008, the processor 112 exits the operational sequence, at step 1010.

FIG. 11 is a timing diagram 1100 that illustrates an example of a flight ticket swap process which will be discussed below. The flight ticket swap process starts 1102 after the seller using the computer device 106 communicates with the flight ticket management server 102 to confirm the start of this process, as has been discussed above. This process is also referred to in the present example as a fixed-price ticket consignment offer. The process ends 1104 when the end of swap time 508 has been reached and the flight ticket has not been sold.

A seating class cumulative purchase curve 1106 (in this example a straight line) illustrates an increasing number of class seating purchases over time until a class seating full capacity is reached 1108.

It should be noted that a seating class full is not necessarily the same as the entire flight seating is full. For example, there are twenty window seats in a flight, as shown in FIG. 2. The entire flight might have 120 total seats. A seating class full would be equal to all twenty seats having been sold, which includes the empty seat of the seller requesting to swap their flight ticket. After the seating class of window seats is full, the seller's window seat flight ticket is made available for purchase by a subsequent buyer, as long as the current market price for the window seat flight ticket is equal to or higher than the price of the seller's flight ticket. This price for the seller's flight ticket can be the original price paid by the seller, or it can be a lower amount that during the ticket swap process the seller selected to reset the flight ticket price to equal the lower current market price for the window seat flight ticket.

During a time period 1110 in which class seating has not reached full seating capacity, the seller is waiting before the seller's flight ticket can be sold. This time interval 1110, 1112, is indicated in the timing diagram by the symbol (A). During this waiting period 1110, 1112, the seller using the computer device 106 can request a change to the current ticket swap offer details 510. For example, the seller could change the flight ticket price to be the same as the lower current market price for the window seat flight ticket. As a second example, the seller might change the current ticket swap offer details to receive rewards (e.g., flight miles toward purchasing prizes or other benefits) instead of receiving a discounted voucher for cash or trade-in for a future purchased flight ticket.

The flight ticket management server 102 periodically sends a Query Message to the seller's computer device 106 which notifies the seller of the current status of the flight ticket swap process at the flight ticket management server 102, and asks the seller if they want a change to the current seller ticket swap offer details 512. The Query Message from the flight ticket management server 102 is received by the user computer device 106 and the user output interface 137 displays the options available to the seller to select a change to the seller ticket swap offer details 512. See FIG. 1 for an example display of options that might be available to a seller. According to the present example, the option to swap ticket at current market price of flight ticket 142, 145, is not displayed in the user output interface 137 because this option is not available to the seller during this time period 1110, 1112. However, in various embodiments the option to swap seller's ticket at current market price of flight ticket 142, 145, can be displayed and made available to the seller to select that option.

The seller flight ticket swap agent 408 in the computer device 106 interoperates with the user interface 136 to display options 138, 140, to the seller using the user output interface 137 and to receive manual confirmation from the user of the selection of a change in any of the options 138, 140. In response to the user selecting one or more of the selectable display elements 143, 144, one or more changes to the seller swap offer details 512 can be made by the processor 112 after receiving a manual confirmation (e.g., selection of the selectable display element 146) from the computer device 106, which confirms that the seller has manually selected to make the change in the selected one or more options. In this example, when the user selects a button 146 on the user output interface 137, the processor 112 in the server 102 stores in the ticket record 116 in the inventory database 114 the user selections for the options in the seller swap offer details 512.

During the time period 1108 in which the class seating is full, the seller's flight ticket can be sold to a buyer as long as the market sale price of the flight ticket is equal to or greater than the price of the flight ticket 510 which is referenced by the seller swap offer details 512 stored in the ticket record 116. During this time period 1108, according to the present example, the flight ticket swap offer becomes locked 1116. It cannot be further changed by the seller, except for an option 142, 145, in which the market sale price of the seller's flight ticket is lower than the current flight ticket sale price. This time interval 1114, 1118, is indicated in the timing diagram by the symbol (B). The flight ticket sale price is set by a fixed-fee ticket consignment agreement between the airline and the seller, and which is tracked by the flight ticket management server 102. According to this option, seller and user of the computer device 106 can see on the user output interface (display) 137 the details 142 of the option to set the swap ticket price at the current market price of the flight ticket. The seller can select the button 145 to confirm the flight ticket price is now set to the current market flight ticket sale price. This option lowers the seller's ticket price to match the current market sale price for the flight ticket. By selecting this option, the seller can advance the swap ticket process past the time interval (B) 1118 such that the flight ticket management server 102 sets the status of the seller's flight ticket to immediately available for sale to buyers. That is, the seller's flight ticket is now on sale to buyers until the end of swap ticket time 508, 1104. This time interval 1120, 1122, is indicated in the timing diagram by the symbol (C).

### Non-limiting Examples

The present invention may be implemented as a system and/or a method, at any possible technical detail level of integration.

The flowchart and block diagrams in the Figures illustrate the architecture, functionality, and operation of possible implementations of systems, methods, and computer programs, according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present specification may describe components and functions implemented in various examples with reference to particular standards and protocols, the invention is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description and the following claims. Other embodiments may be utilized and derived therefrom, such that structural and logical substitutions and changes may be made without departing from the scope of this invention. Figures are also merely representational and may not be drawn to scale. Certain proportions thereof may be exaggerated, while others may be minimized. Accordingly, the specification and drawings are to be regarded in an illustrative rather than a restrictive sense. For the sake of clarity and succinctness, the components and details which are not essential in order to explain the scope of the invention have been omitted in the drawings.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, optical, wired, wireless, or other communications media. The terms “communicatively coupled” or “communicatively coupling” include, but are not limited to, communicating light signals and/or electronic control signals, by which one element may direct or control another. The term “configured to” describes one or more structures, or a combination of structures, that is set up, arranged, built, composed, constructed, designed or that has any combination of these characteristics to carry out a given function. The term “adapted to” describes one or more structures or a combination of structures that is capable of, able to accommodate, to make, or that is suitable to carry out a given function.

It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted herein by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The corresponding structures, materials, acts, and equivalents of all means or step plus function elements in the claims below are intended to include any structure, material, or act for performing the function in combination with other claimed elements as specifically claimed.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. A processing system may include one or more processing systems or processors. A processing system can be realized in a centralized fashion in one processing system or in a distributed fashion where different elements are spread across several interconnected processing systems.

The description of the various embodiments of the present invention has been presented by various examples for purposes of illustration and description, but is not intended to be exhaustive or limited to the invention in the form disclosed. Many modifications and variations will be apparent to those of ordinary skill in the art without departing from the scope of the invention. The examples were chosen and described in order to best explain the principles of the invention and the practical application, and to enable others of ordinary skill in the art to understand the invention for various embodiments with various modifications as are suited to the particular use contemplated.

1. An airline flight ticket management system, comprising:
a flight ticket management server communicatively coupled with a flight ticket database system comprising a multiplicity of flight ticket records associated with a respective multiplicity of flight tickets each associated with a seat on an airline flight, the flight ticket management server including:
a computer processor;
storage memory coupled to the computer processor; and
a network interface coupled to the computer processor, and further communicatively coupled with a multiplicity of user computer devices, via one or more computer networks, each individual user computer device in the multiplicity being associated with a respective seller of a previously purchased and unused flight ticket; and wherein
the computer processor, in response to executing computer instructions, performing the following method:
receiving, via the one or more computer networks, ticket swap request messages from the user computer devices, individual requests to swap unused flight tickets from respective sellers of previously purchased and unused flight tickets from one or more flight ticket issuing airlines, each of the flight tickets comprising one or more of flight details, seat assignment, seating class, date and time of the flight, and purchase price paid for the flight ticket;
sending, via the one or more computer networks, Query Messages addressed and destined for reception by the individual user computer devices prompting the respective sellers to confirm the details of their requests to swap their unused flight tickets, each Query Message including a web page link that when followed by a browser application operating in a respective seller's user computer device points to a web page on an information processing system communicatively coupled with the one or more computer networks;
receiving, by the flight ticket management server, an Automatic Response transmitted by a respective seller's user computer device, without human intervention and independent of a user being at the seller's user computer device, in response to receiving one of the Query Messages, the Automatic Response including local flight ticket swap offer details from the respective seller which were previously collected and stored in a local storage memory data repository of the respective seller's user computer device, since a most recent time a Query Message was received;
generating, with the flight ticket management server after sending the Query Message and in response to receiving the Automatic Response, displayable user information in the web page, the displayable user information including:
a) permanent flight ticket swap offer details from the flight ticket record associated with the flight ticket of the respective seller, and
b) local flight ticket swap offer details from the local storage memory data repository of the respective seller's user computer device which was received in the Automatic Response; and
generating, with the flight ticket management server, at least one user-selectable user interface element in the web page that when manually selected via a browser application operating in the respective seller's user computer device selects at least one of the displayable user information a) or b) associated with any one or more of:
the respective seller's offer of swap ticket for voucher details;
the respective seller's offer of swap ticket for rewards details; or
the respective seller's offer of swap ticket at current market price of the flight ticket, as manual confirmation of the respective seller's manual selection of a) or b) for seller's current permanent flight ticket swap offer details.

2. The airline flight ticket management system of claim 1, wherein the Automatic Response includes an information field indicating a status of a user's current use of the respective seller's user computer device contemporaneous with receiving the Query Message at the respective seller's user computer device, and wherein in response to receiving the Automatic Response the flight ticket management server checks the information field to determine whether the seller is using the respective seller's user computer device contemporaneous with receiving the Query Message.

3. The airline flight ticket management system of claim 2, wherein based on the determining that the seller is not using the respective seller's user computer device, the flight ticket management server stops monitoring the web page for a user manual confirmation response.

4. The airline flight ticket management system of claim 1, wherein based on the flight ticket management server detecting from the web page a manual confirmation of the respective seller's manual selection of a) or b), associated with any one or more of:
the respective seller's offer of swap ticket for voucher details;
the respective seller's offer of swap ticket for rewards details; or
the respective seller's offer of swap ticket at current market price of the flight ticket, the flight ticket management server updating a change requested by the seller to the flight ticket record associated with the seller's flight ticket.

5. The airline flight ticket management system of claim 1, wherein the flight ticket management server updating a flight ticket record to indicate that a flight ticket is available to be purchased by a subsequent buyer of the flight ticket, based on determining that a flight class seating capacity has reached full capacity for a seating class indicated in the flight ticket record.

6. The airline flight ticket management system of claim 5, wherein the seating class indicated in the flight ticket record comprises at least one of:
window seat location;
aisle seat location; or
bulkhead seat location.

7. The airline flight ticket management system of claim 5, wherein in response to the determining the flight ticket management server stops sending Query Messages to a seller's user computer device for the flight ticket record associated with a previously purchased and unused flight ticket which is requested to be swapped by a seller.

8. The airline flight ticket management system of claim 1, wherein the flight ticket management server updating a flight ticket record, associated with a previously purchased and unused flight ticket which is requested to be swapped by a seller, to indicate that the flight ticket is available to be purchased by a subsequent buyer of the flight ticket, based on determining that
a flight class seating capacity has reached full capacity for a seating class indicated in the flight ticket record, and
a market price for the associated flight ticket is greater than or equal to a price of the flight ticket indicated in the flight ticket record.

9. The airline flight ticket management system of claim 8, wherein the seating class indicated in the flight ticket record comprises at least one of:
window seat location;
aisle seat location; or
bulkhead seat location.

10. The airline flight ticket management system of claim 8, wherein in response to the determining the flight ticket management server stops sending Query Messages to a seller's user computer device for the flight ticket record associated with a previously purchased and unused flight ticket which is requested to be swapped by a seller.

11. A method in an airline flight ticket management system, comprising:
receiving, by a flight ticket management server via one or more computer networks, ticket swap request messages from user computer devices, the ticket swap request messages respectively comprising requests to swap unused flight tickets from respective sellers of previously purchased and unused flight tickets;
maintaining in a flight ticket database system a multiplicity of flight ticket records associated with a respective multiplicity of flight tickets each associated with a seat on an airline flight, each flight ticket record including one or more of flight details, seat assignment, seating class, date and time of the flight, and purchase price paid for the flight ticket;
updating flight ticket records in the flight ticket database system based on the received ticket swap request messages from user computer devices, to indicate that each updated flight ticket record is associated with a request to swap unused flight tickets from respective sellers of previously purchased and unused flight tickets;
sending, via the one or more computer networks, Query Messages addressed and destined for reception by individual user computer devices prompting respective sellers of previously purchased and unused flight tickets to confirm the details of their requests to swap their unused flight tickets;
receiving, by the flight ticket management server, an Automatic Response transmitted by a respective seller's user computer device, without human intervention and independent of a user being at the seller's user computer device, in response to receiving one of the Query Messages, the Automatic Response including local flight ticket swap offer details from the respective seller which were previously collected and stored in a local storage memory data repository of the respective seller's user computer device, since a most recent time a Query Message was received, the local flight ticket swap offer details from each respective seller including any one or more of:
the respective seller's offer of swap ticket for voucher details;
the respective seller's offer of swap ticket for rewards details; or
the respective seller's offer of swap ticket at current market price of the flight ticket; and
receiving, by the flight ticket management server, a manual confirmation of the respective seller's manual selection of a change to the respective seller's current permanent flight ticket swap offer details stored in the associated flight ticket record in the flight ticket database system.

12. The method of claim 11, further comprising:
sending, via the one or more computer networks, Query Messages addressed and destined for reception by the individual user computer devices prompting the respective sellers to confirm the details of their requests to swap their unused flight tickets, each Query Message including a web page link that when followed by a browser application operating in a respective seller's user computer device points to a web page on an information processing system communicatively coupled with the one or more computer networks;
receiving, by the flight ticket management server, an Automatic Response transmitted by a respective seller's user computer device, without human intervention and independent of a user being at the seller's user computer device, in response to receiving one of the Query Messages, the Automatic Response including local flight ticket swap offer details from the respective seller which were previously collected and stored in a local storage memory data repository of the respective seller's user computer device, since a most recent time a Query Message was received;
generating, with the flight ticket management server after sending the Query Message and in response to receiving the Automatic Response, displayable user information in the web page, the displayable user information including:
a) permanent flight ticket swap offer details from the flight ticket record associated with the flight ticket of the respective seller, and
b) local flight ticket swap offer details from the local storage memory data repository of the respective seller's user computer device which was received in the Automatic Response; and
generating, with the flight ticket management server, at least one user-selectable user interface element in the web page that when manually selected via a browser application operating in the respective seller's user computer device selects at least one of the displayable user information a) or b) associated with any one or more of:
the respective seller's offer of swap ticket for voucher details;
the respective seller's offer of swap ticket for rewards details; or
the respective seller's offer of swap ticket at current market price of the flight ticket, as manual confirmation of the respective seller's manual selection of a) or b) for seller's current permanent flight ticket swap offer details.

13. The method of claim 12, wherein the Automatic Response includes an information field indicating a status of a user's current use of the respective seller's user computer device contemporaneous with receiving the Query Message at the respective seller's user computer device, and wherein in response to receiving the Automatic Response the flight ticket management server checks the information field to determine whether the seller is using the respective seller's user computer device contemporaneous with receiving the Query Message.

14. The method of claim 12, wherein based on the determining that the seller is not using the respective seller's user computer device, the flight ticket management server stops monitoring the web page for a user manual confirmation response.

15. The method of claim 12, wherein based on the flight ticket management server detecting from the web page a manual confirmation of the respective seller's manual selection of a) or b), associated with any one or more of:
the respective seller's offer of swap ticket for voucher details;
the respective seller's offer of swap ticket for rewards details; or
the respective seller's offer of swap ticket at current market price of the flight ticket, the flight ticket management server updating a change requested by the seller to the flight ticket record associated with the seller's flight ticket.

16. The method of claim 12, wherein the flight ticket management server updating a flight ticket record, associated with a previously purchased and unused flight ticket which is requested to be swapped by a seller, to indicate that the flight ticket is available to be purchased by a subsequent buyer of the flight ticket, based on determining that
a flight class seating capacity has reached full capacity for a seating class indicated in the flight ticket record, and
a market price for the associated flight ticket is greater than or equal to a price of the flight ticket indicated in the flight ticket record.

17. The method of claim 16, wherein the seating class indicated in the flight ticket record comprises at least one of:
window seat location;
aisle seat location; or
bulkhead seat location.

18. The airline flight ticket management system of claim 16, wherein in response to the determining the flight ticket management server stops sending Query Messages to a seller's user computer device for the flight ticket record associated with a previously purchased and unused flight ticket which is requested to be swapped by a seller.

19. An information processing system suitable for use in a commercial carrier ticket management system, comprising:
a commercial carrier ticket management server (CCTMS) communicatively coupled with a passenger ticket database system (PTDBS) comprising a multiplicity of commercial carrier ticket records (CCTR) associated with a respective multiplicity of tickets each associated with at least one person's reserved trip on a commercial carrier, the CCTMS including:
a computer processor;
storage memory coupled to the computer processor; and
a network interface coupled to the computer processor, and further communicatively coupled with a multiplicity of user computer devices, via one or more computer networks, each individual user computer device in the multiplicity being associated with a respective seller of a previously purchased and unused ticket for a trip on a commercial carrier; and wherein
the computer processor, in response to executing computer instructions, performing the following method:
collecting, by receiving via the one or more computer networks, ticket swap request messages from the user computer devices, individual requests to swap unused tickets from respective sellers of previously purchased and unused tickets from one or more ticket issuing commercial carriers, each of the ticket swap request messages comprising one or more of trip details, seat assignment, seat class, date and time of the trip, and purchase price paid for the ticket;
sending, via the one or more computer networks, Query Messages addressed and destined for reception by the individual user computer devices prompting the respective sellers to confirm the details of their requests to swap their unused tickets, each Query Message including a web page link that when followed by a browser application operating in a respective seller's user computer device points to a web page on an information processing system communicatively coupled with the one or more computer networks;
receiving, by the CCTMS, an Automatic Response transmitted by a respective seller's user computer device, without human intervention and independent of a user being at the seller's user computer device, in response to receiving one of the Query Messages, the Automatic Response including local ticket swap offer details from the respective seller which were previously collected and stored in a local storage memory data repository of the respective seller's user computer device, since a most recent time a Query Message was received;
generating, with the CCTMS after sending the Query Message and in response to receiving the Automatic Response, displayable user information in the web page, the displayable user information including:
a) permanent ticket swap offer details from the CCTR associated with the ticket of the respective seller, and
b) local ticket swap offer details from the local storage memory data repository of the respective seller's user computer device which was received in the Automatic Response; and
generating, with the CCTMS, at least one user-selectable user interface element in the web page that when manually selected via a browser application operating in the respective seller's user computer device selects at least one of the displayable user information a) or b) associated with any one or more of:
the respective seller's offer of swap ticket for voucher details;
the respective seller's offer of swap ticket for rewards details; or
the respective seller's offer of swap ticket at current market price of the ticket, as manual confirmation of the respective seller's manual selection of a) or b) for seller's current permanent ticket swap offer details.

20. The information processing system of claim 19, wherein the flight ticket management server updating a flight ticket record, associated with a previously purchased and unused flight ticket which is requested to be swapped by a seller, to indicate that the flight ticket is available to be purchased by a subsequent buyer of the flight ticket, based on determining that
a flight class seating capacity has reached full capacity for a seating class indicated in the flight ticket record, and
a market price for the associated flight ticket is greater than or equal to a price of the flight ticket indicated in the flight ticket record.
